(19) United States
(12) Patent Application Publication
(10) Pub. No.: US 2008/0106887 A1
(43) Pub. Date: May 8, 2008

(54) LIGHT SOURCE COMPRISING A LIGHT-EXCITABLE MEDIUM

(75) Inventors: Marc SALSBURY, Vancouver (CA); Ian ASHDOWN, West Vancouver (CA)

Correspondence Address: SHERIDAN ROSS PC, 1560 BROADWAY, SUITE 1200, DENVER, CO, 80202, US

(73) Assignee: TIR TECHNOLOGY LP, Burnaby (CA)

(21) Appl. No.: 11/928,236

(22) Filed: Oct. 30, 2007

Related U.S. Application Data
(60) Provisional application No. 60/855,434, filed on Oct. 31, 2006.

(51) Int. Cl. F21V 9/16; F21V 9/00

(52) U.S. Cl. 362/84; 362/231

(57) ABSTRACT

The present invention provides a light source having an improved output optical quality. In general, the light source comprises one or more light-emitting elements in each of at least a first, a second and a third colour. The combined spectral power distribution of these light-emitting elements generally defines a spectral concavity. The light source further comprises a light-excitable medium configured and disposed to absorb a portion of the light emitted by one or more of the light-emitting elements and emit light defined by a complementary spectral power distribution having a peak located within the concavity. By combining the spectral output of the light-emitting elements with the spectral output of the light-excitable medium, an optical quality of the light source is improved.

### FIELD OF THE INVENTION

The present invention pertains to the field of lighting and in particular to a light source comprising a light-excitable medium.

### BACKGROUND

Advances in the development and improvements of the luminous flux of light-emitting devices such as solid-state semiconductor and organic light-emitting diodes (LEDs) have made these devices suitable for use in general illumination applications, including architectural, entertainment, and roadway lighting. Light-emitting diodes are becoming increasingly competitive with light sources such as incandescent, fluorescent, and high-intensity discharge lamps. Also, with the increasing selection of LED wavelengths to choose from, white light and colour changing LED light sources are becoming more popular.

White LED light sources may be constructed in a number of ways. One such construction includes red, green and blue LEDs, the output of which being mixed to produce white light. Alternatively, a high energy LED, such as a blue or ultraviolet (UV) LED, may be used to pump a phosphor to emit light of another colour, such as red or green, and be combined therewith, and optionally with the emission of a complementary LED, in order to achieve similar results.

Examples of light sources combining LEDs and LED-activated phosphors are disclosed in U.S. Pat. Nos. 6,799,865, 7,005,679, and 6,686,691. In the first two references, a white light source is disclosed to include an ultraviolet (UV) LED, a conversion material configured to absorb the UV light and re-emit light at two different wavelengths (i.e. red and green), and one or more complementary LEDs (i.e. blue LEDs). The respective outputs of the conversion material and of the complementary LEDs are mixed to provide white light. Alternatively, in the latter reference, white light is generated by combining a blue LED with red and green phosphors configured to absorb a portion of the blue light such that light emitted from the two phosphors, and the unabsorbed light emitted from the blue LED, is mixed to produce white light.

Other examples of white light sources combining LEDs with LED-activated phosphors are found in U.S. Pat. Nos. 6,541,800, 6,590,235, 6,813,753, 6,943,380 and 6,501,102, and in International Patent Application No. WO 2006/047306.

A similar type of LED-based white light source is disclosed in U.S. Pat. No. 6,513,949, wherein LED/Phosphor-LED hybrid lighting systems for producing white light are described to include at least one light emitting diode and phosphor-light emitting diode, wherein different lighting system performance parameters may be adjusted by varying the colour and number of the LEDs and/or the phosphor of the phosphor LED.

Also, in U.S. Pat. No. 6,817,735, an illumination light source is disclosed which includes four different types of LEDs, namely a blue light-emitting diode, a blue-green light-emitting diode, an orange light-emitting diode and a red light-emitting diode, the combination reportedly providing a high efficiency and high colour rendering performance. This reference, however, requires the use of an orange LED in addition to traditional RGB LEDs, which may not be suitable for certain applications. For instance, orange LEDs are typically inefficient and thus typically avoided when possible.

There is therefore a need for a light source that overcomes some of the drawbacks of the above and other known lights sources.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a light source comprising a light-excitable medium. In accordance with an aspect of the present invention, there is provided a light source, comprising: one or more light-emitting elements in each of at least a first, a second and a third colour, a combined spectral power distribution thereof defining a spectral concavity having a minimum located between about 550 nm and about 600 nm; and a light-excitable medium configured and disposed to absorb a portion of the light emitted by one or more of said light-emitting elements and emit light defined by a complementary spectral power distribution having a peak located within said concavity; wherein an optical quality of the light source output is improved by a combination of said complementary spectral power distribution with said combined spectral power distribution.

In accordance with another aspect of the present invention, there is provided a light source, comprising: one or more light-emitting elements in each of at least a first and a second colour, a combined spectral power distribution thereof defining a spectral deficiency between about 550 nm and about 600 nm; and one or more light-excitable media configured and disposed to absorb a portion of the light emitted by one or more of said light-emitting elements and emit light defined by a complementary spectral power distribution having a peak located between about 550 nm and about 600 nm; wherein an optical quality of the light source output is improved by a combination of said complementary spectral power distribution with said combined spectral power distribution.

### BRIEF DESCRIPTION OF THE FIGURES

FIG. 1 is a graphical representation of the spectral power distribution of an RGB light source.

FIG. 2 is a graphical representation of the spectral power distribution of an RGB light source comprising a broadband light-excitable medium in accordance with an embodiment of the present invention.

FIG. 3 is a graphical representation of the spectral power distribution of an RGB light source comprising a narrowband light-excitable medium in accordance with another embodiment of the present invention.

FIG. 4 is a diagrammatical front side view of a light source in accordance with one embodiment of the present invention.

FIG. 5 is a diagrammatical front side view of a light source in accordance with another embodiment of the present invention.

FIG. 6 is a diagrammatical front side view of a light source in accordance with another embodiment of the present invention.

FIG. 7 is a diagrammatical front side view of a light source in accordance with another embodiment of the present invention.

FIG. 8 is a diagrammatical front side view of a light source in accordance with another embodiment of the present invention.

FIG. 9 is a diagrammatical front side view of a light source in accordance with another embodiment of the present invention.

FIG. 10 is a diagrammatical front side view of a light source in accordance with another embodiment of the present invention.

### DETAILED DESCRIPTION OF THE INVENTION

### Definitions

The term “light-emitting element” is used to define a device that emits radiation in a region or combination of regions of the electromagnetic spectrum for example, the visible region, infrared and/or ultraviolet region, when activated by applying a potential difference across it or passing a current through it, for example. Therefore a light-emitting element can have monochromatic, quasi-monochromatic, polychromatic or broadband spectral emission characteristics. Examples of light-emitting elements include semiconductor, organic, or polymer/polymeric light-emitting diodes, optically pumped phosphor coated light-emitting diodes, optically pumped nano-crystal light-emitting diodes or other similar devices as would be readily understood by a worker skilled in the art. Furthermore, the term light-emitting element is used to define the specific device that emits the radiation, and can equally be used to define a combination of the specific device that emits the radiation together with a housing or package within which the specific device or devices are placed.

The terms “spectral power distribution” and “spectral output” are used interchangeably to define the overall general spectral output of a light source and/or of the light-emitting element(s) thereof. In general, these terms are used to define a spectral content of the light emitted by the light source/light-emitting element(s).

The term “colour” is used to define the overall general output of a light source and/or of the light-emitting element(s) thereof as perceived by a human subject. Each colour is usually associated with a given peak wavelength or range of wavelengths in a given region of the visible or near-visible spectrum, for example, between and including ultraviolet to infrared, but may also be used to describe a combination of such wavelengths within a combined spectral power distribution generally perceived and identified as a resultant colour of the spectral combination.

As used herein, the term “about” refers to a +/−10% variation from the nominal value, unless referring to a wavelength wherein the term “about” refers to a +/−50 nm variation from the nominal wavelength. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

The present invention provides a light source comprising a light-excitable medium which improves the output optical quality of the light-source. The light source comprises one or more light-emitting elements in each of at least a first and a second colour, or in at least a first, a second and a third colour, the combined spectral power distribution of these light-emitting elements generally defining a spectral deficiency between about 550 nm and about 600 nm, for example a concavity having a minimum located within this region. The light source further comprises a light-excitable medium configured and disposed to absorb a portion of the light emitted by one or more of the light-emitting elements and emit light defined by a complementary spectral power distribution having a peak located within this range, for example with a concavity in the spectral power distribution defined in this range, for example. By combining the spectral output of the light-emitting elements with the spectral output of the light-excitable medium, the optical quality of the light source is improved.

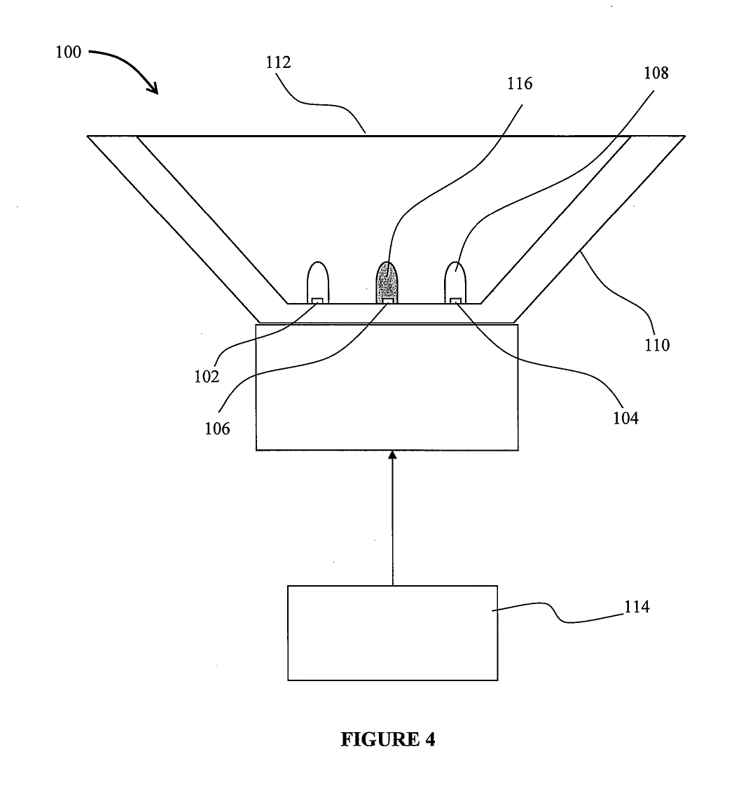

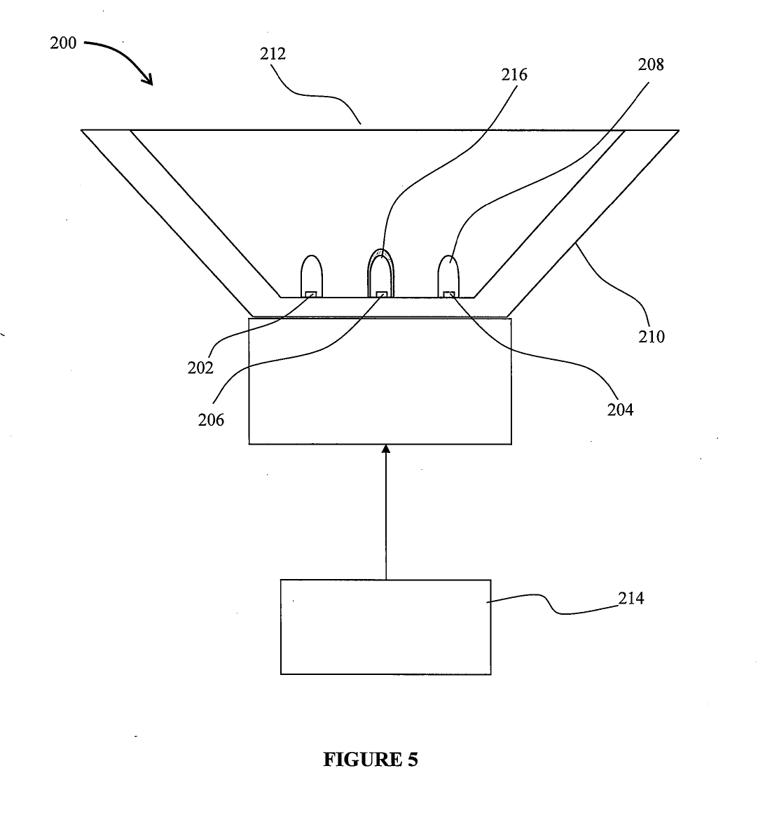

Various embodiments of the light source are illustrated in FIGS. 4 to 10, wherein like parts are referenced using like numbers. For reasons of clarity, the following will be cast with particular reference to the embodiment of FIG. 4. The person skilled in the art, however, will readily appreciate that the following general discussion is equally applicable to the embodiments of FIGS. 5 to 10, as well as to other embodiments of the present invention that may comprise different numbers or combinations of the variants and/or permutations recited hereinbelow, and/or other such variants as would be readily apparent to this skilled person.

As stated above, the light source according to an embodiment of the present invention, generally comprises one or more light-emitting elements in each of at least three colours, illustrated in FIG. 4 as elements 102, 104 and 106, respectively. The light-emitting elements of the light source may be mounted within respective packages, as in package 108, or combined within one or more shared packages. The packages 108 may each optionally comprise a primary output optics, which may include, but is not limited to, one or more lenses, diffusers, filters and/or other such optical elements known in the art, for directing at least a portion of the light emitted by the light-emitting elements toward an output of the light source. Such package optics, however, may not be needed as other optical configurations may be considered to provide similar effects, as will be readily understood by the person skilled in the art.

In general, light emitting elements 102, 104 and 106 are operatively mounted within their respective or shared packages 108 on a substrate or the like. A shared and/or respective driving mechanism, for example a driver, drive circuitry, or the like, may be operatively coupled thereto and to a power source 114 for driving the light-emitting elements. An optional control module, such as a micro-controller, a combination of hardware, software and/or firmware, or the like, may also be included and operatively coupled to the driving mechanism in order to control, and possibly optimise, an output of the light-emitting elements and/or a combined output of the light source. Various driving and optional control systems may be considered herein without departing from the general scope and nature of the present disclosure, as will be discussed further below.

The light-emitting elements 102, 104 and 106, within their respective and/or shared packages 108, may be mounted within a light source housing 110, or the like, which generally defines an optical output 112 of the light source. As will be apparent to the person skilled in the art, the housing 110 may comprise a number of optical and/or non-optical components to provide a variety of optical effects. These components may include, but are not limited to, a number of reflective surfaces, lenses, diffusers, filters, and the like, used in various combinations to provide a desired effect.

According to embodiments of the present invention, the light source may comprise three or more discrete light-emitting elements of different colours, as illustrated in FIGS. 4 to 9, or may comprise a combination, cluster, configuration, agglomeration and/or array of such elements without departing from the general scope and nature of the present disclosure. Also, the person of skill in the art will understand that one or more light-emitting elements, whether they be of a same or different colour, of a same or different type, and/or of a same or different size, may be mounted and operated within respective packages, or within one or more shared packages.

Furthermore, various optical and/or operational configurations may be considered. Namely, the light source may comprise three or more independent light-emitting elements, as illustrated in FIGS. 4 to 9, one or more arrays of such elements for each selected colour (e.g., an array of red light-emitting elements, an array of green light-emitting elements and an array of blue light-emitting elements, etc.), or different combinations and/or spatial configurations thereof.

Also, it will be appreciated that similar light sources may be designed to include one or more light-emitting elements in each of only a first and second colour (e.g. red and blue), such that a portion of the light emitted by one or more of the light-emitting elements is absorbed the light-excitable medium and re-emitted in a spectral range complementary to the combined spectral power distribution of the light-emitting elements. For example, a spectral deficiency between about 550 nm and about 600 nm may be exhibited by the combined spectral power distribution of the light-emitting elements, to be complimented by the spectral power distribution of the light emitted by light-excitable medium.

It will be further appreciated that a combination of two or more light-excitable media, or a light-excitable medium providing a combination of two or more spectral contributions, may be considered herein without departing from the general scope and nature of the present disclosure. For example, the light-excitable medium or media may be configured to emit light within the spectral deficiency exhibited, for example, between about 550 nm and 600 nm, but also emit light within other ranges of the visible spectrum, to compliment emissions from one or more light-emitting elements in these regions, or again to address further spectral deficiencies in these regions.

Combined Spectral Power Distribution

The light emitted by the light source's light-emitting elements is generally mixed and combined, for instance via the respective light-emitting element package optics, the light source output optics and/or other combinations of optical elements provided with the light source, resulting in a substantially combined spectral power distribution. This combined spectral power distribution, which generally accounts for the spectral/colour contribution of each light-emitting element, cluster, group, agglomeration and/or array thereof, is in most cases determinative, at least in part, of the light source's output optical quality.

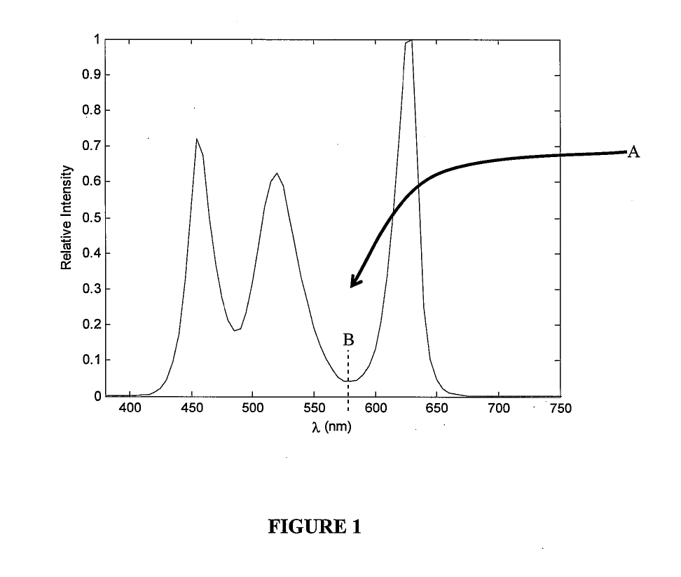

In FIG. 1, a typical RGB spectrum at 6500 K is illustrated. This combined spectral power distribution, illustrative of a traditional combination of readily available light-emitting elements, such as for example red, green and blue light-emitting diodes, defines a general spectral deficiency between about 550 nm and about 600 nm. In general terms, this spectral deficiency, illustratively described herein as a spectral concavity A having a minimum B located within this range, is one of the main contributing factors to the relatively low colour rendering index (CRI) of light-emitting element-based RGB light sources, for example.

As will be understood by the person of skill in the art, various combinations of three or more light-emitting elements of different colours can yield such a spectral concavity and thereby possess a similar spectral deficiency with regards to colour rendition, and to other such light source output qualities as will be further defined hereinbelow. For example, red and/or orange-red, green and/or yellow-green, and cyan, blue and/or violet-blue light-emitting elements may come in different peak output wavelengths (e.g. 610-660 nm, 500-530 nm and 420-500 nm, respectively). Other similar colours may also be considered. Furthermore, different light-emitting elements may have different bandwidths, spectral power distributions, and/or output efficiencies resulting in a number of possible spectral combinations each yielding a combined spectral output broadly defined by the spectral characteristics illustrated in FIG. 1, namely defining a spectral deficiency, herein termed as a spectral concavity, within the range of about 550 nm to about 600 nm.

For example, while high-flux aluminium-indium-gallium-nitride (AlInGaN) light-emitting elements are available which can generate visible light from about 380 nm to about 530 nm and high-flux aluminum-indium-gallium-phosphide (AlInGaP) light-emitting elements are available which can generate visible light from about 610 nm to about 660 nm, there are generally no suitable commercially available semiconductor light-emitting elements with peak wavelengths in the region of about 530 nm to about 610 nm. Namely, while high-flux AlInGaP amber light-emitting elements are available with peak wavelengths in the region of about 585 nm to about 595 nm, they generally exhibit extreme temperature dependencies and narrow spectral bandwidths that makes this format of light-emitting element typically unsuitable for most applications where a relatively good colour rendering index (CRI) and/or relatively specific colour temperature are desired, for example.

In one embodiment, the spectral concavity defined by the three or more colours of light-emitting elements comprises a minimum located within the range of about 550 nm to about 600 nm. As will be appreciated by the person of skill in the art, this minimum may consist of a local minimum, a global minimum, or consist of one of many such minima within this range. Other visible minima outside this range, for example beyond about 650 nm and below about 420 nm, or again between 470 nm and 500 nm, for example, may also exist, as will be readily apparent to the person of skill in the art.

In another embodiment, the spectral concavity defined by the three or more colours of light-emitting elements comprises a minimum located within the range of about 560 nm to about 590 nm.

In yet another embodiment, the spectral concavity defined by the three or more colours of light-emitting elements comprises a minimum located within the range of about 570 nm to about 585 nm.

In yet another embodiment, the spectral concavity defined by the three or more colours of light-emitting elements comprises a minimum located at about 575+/−5 nm or at about 580+/−5 nm.

Furthermore, due to the types of available light-emitting elements, and the variety in output characteristics thereof, the spectral concavity described and illustrated herein may take various shapes. For instance, a spectral concavity resulting from a given combination of three or more light-emitting element colours may range from being substantially symmetric to being completely asymmetric depending mainly on the spectral power distributions of the light-emitting elements yielding peak outputs adjacent the concavity (i.e. red and green). Also, various undulations, rises and/or dips may be manifested within the concavity as a result of one or more side bands emitted by the light-emitting elements, or again generated by the tail ends of the light-emitting element peaks. Such variations should be readily understood by the person of skill in the art and are thus not meant to depart from the general scope and nature of the present disclosure.

Furthermore, it will be appreciated that similar light sources may be designed to include one or more light-emitting elements in each of only a first and second colour (e.g. red and blue), thereby defining a spectral deficiency within the above-reference region, but also possibly defining a further spectral deficiency within other regions of the visible spectrum, namely in the green and/or yellow ranges of this spectrum. A complementary spectral power distribution accounting for such additional deficiencies may be provided, for example, via an additional light-excitable medium, or again via a common light-excitable medium exhibiting various peak emissions, for example. Such light-excitable media may also be beneficial, for example to supplement emissions from one or more relatively weak light-emitting elements emitting light in a given region of the visible spectrum (e.g. green, yellow, and/or amber/orange light-emitting elements, etc.).

Light-Excitable Medium

In order to compensate for the lack of spectral content within the spectral deficiency and/or concavity defined by the combined spectral output of the light-emitting elements, and thereby improve an output quality of the light source, a light-excitable medium, such as a phosphor or the like, is included in the light source and configured to be pumped by one or more of the light-emitting elements. In FIGS. 4 to 10, which show example positions and configurations of the light-excitable medium in accordance with different embodiments of the present invention, the light-excitable medium is illustrated, and respectively referenced by the numerals 116, 216, 316, 416, 516, 616 and 716, as a shading of the component or part to which, or within which, the light-excitable medium is applied and/or mounted.

There is a plurality of known phosphorescent compounds and compound families that may be considered herein to provide a desired effect, and likely many more are awaiting discovery. For example, phosphor families applicable in the present context may include, but are not limited to, sulphides, oxides, aluminates, silicates, nitrides, salions, borates, phosphates, quantum dot nanocrystals, and other such families as will be readily understood by the person skilled in the art. Specific examples of phosphorescent compounds may include, but are not limited to, YAG:Ce, TAG:Ce, various sulfoselenides and silicates, and quantum dot nanocrystals whose peak wavelengths are in the region of the spectral concavity. Other such compounds and materials should be readily apparent to the person of skill in the art.

In one embodiment, the light-excitable medium is optically coupled to a light-emitting element whose peak wavelength is closely matched to the peak excitation wavelength of the light-excitable medium. This wavelength will depend on the particulars of the light-emitting element, and may be selected within the ultraviolet, blue and/or green bands for down-conversion media, and within the red or infrared bands for up-conversion media, such as up-conversion phosphors and down-conversion phosphors respectively, for example.

As will be understood by the person skilled in the art, one or more light-emitting elements, in one or more different colours, may be used to excite (e.g. pump) the light-excitable medium. For example, in one embodiment where red, green and blue light-emitting elements are used, the blue light-emitting element(s) acts both as a pump for the light-excitable medium and as a component of the light source output. In another embodiment, both the blue and green light-emitting elements may be used as a pump. In yet another embodiment, an additional UV light-emitting element may be used as a pump, either exclusively, or in combination with blue and/or green light-emitting elements. In still yet another embodiment, a red and/or IR light-emitting element is used to pump and up-convert light-excitable medium.

In an embodiment wherein the pump of the light-excitable medium is chosen in the visible portion of the spectrum, the pump may serve a dual purpose: 1) to control the blue, green, and/or red contribution of the light source output, for example, and 2) to pump the light-excitable medium. This embodiment requires fewer light-emitting elements as one or more separate pump light-emitting elements, such a UV or IR light-emitting element, are not needed. In this embodiment, due to the coupling of blue, green and/or red outputs with the light-excitable medium output, the respective intensities thereof relative to the one or more other colours may also linked.

In an embodiment wherein the pump light-emitting element is chosen outside the visible portion of the spectrum, e.g. ultraviolet, nearly ultraviolet, IR or near-IR, colour control may be enhanced as the output of the light-excitable medium is not linked to the output of the other colours.

In general, a spectral power distribution of the light-excitable medium will have a peak output located within the spectral concavity defined by the combined spectral output of the light-emitting elements. For instance, in one embodiment, the peak may be located between about 550 nm and about 600 nm. In another embodiment, the peak may be located between about 560 nm and about 590 nm. In yet another embodiment, the peak may be located between about 570 nm and 585 nm. In yet another embodiment, the peak may be located at about 575+/−5 nm or at about 580+/−5 nm.

In other embodiments, the light-excitable medium, or a combination thereof, will further include a peak output located within another range of the visible spectrum, for example to account for additional spectral deficiencies of the combined spectral output of the light source, or again to supplement the output of one or more light-emitting elements of a given colour (e.g. green, yellow and/or amber/orange light-emitting element).

Furthermore, the light-excitable medium may comprise a narrowband light-excitable medium or a broadband light-excitable medium. For instance, a narrowband light-excitable medium may comprise a spectral output whose half-width is less than that of the spectral concavity, less than that of one or more of the light-emitting elements and/or less than that of all the light-emitting elements. Such narrowband light-excitable media may provide a precise spectral contribution to the light source within, or in the general vicinity of the spectral concavity.

On the other hand, or in combination with a narrowband light-excitable medium, a broadband light-excitable medium may comprise a spectral output whose half width is greater than that of one or more of the light-emitting elements, greater than that of all light-emitting elements, and/or greater than that of the spectral concavity. Such broadband light-excitable media may provide both a spectral contribution to the light source within, or in the general vicinity of the spectral concavity, as well as supplement a spectral contribution of the light source within other spectral regions. For example, a broadband light-excitable medium may be used to increase a spectral component of the light source in the deep reds, where traditional light-emitting diodes are often deficient. Other such considerations should be apparent to the person of skill in the art.

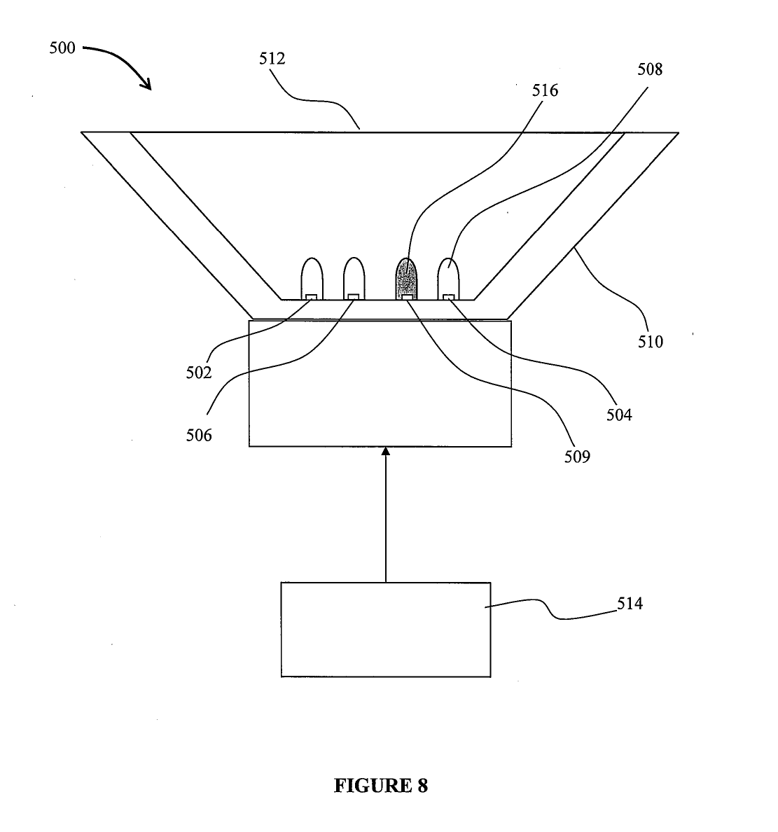

In order to optically couple the light-excitable medium to the one or more pump light-emitting elements, various configurations may be considered. In one embodiment, the light-excitable medium is impregnated in a lens of the pump light-emitting element package at the manufacturing stage (e.g. see FIGS. 4 and 8). This results in the lens acting as a light emitter itself. Some advantages of this configuration include the fact that additional heat may not be introduced into a PCB upon which the light-emitting elements are mounted and that the output colours of the light-emitting elements and the light-excitable medium would be well mixed. Furthermore, as some light-excitable media degrade with repeated exposure to elevated temperatures (e.g. quantum dot phosphors, etc.), distancing such light-excitable media from the light-emitting elements, which generally absorb light and heat up during operation, could extend the lifetime and properties of such media. In another example, the light-excitable medium can be applied to the edge or surface of the lens itself (e.g. see FIG. 5). This embodiment can reduce a need for corrective optics in order to focus the light emitted by the light-excitable medium, for example.

In another embodiment, the light-excitable medium is disposed directly on the pump light-emitting element(s), for instance directly on an LED die or the like.

In another embodiment, the light-excitable medium is impregnated within an encapsulant material of a light-emitting element package or the like.

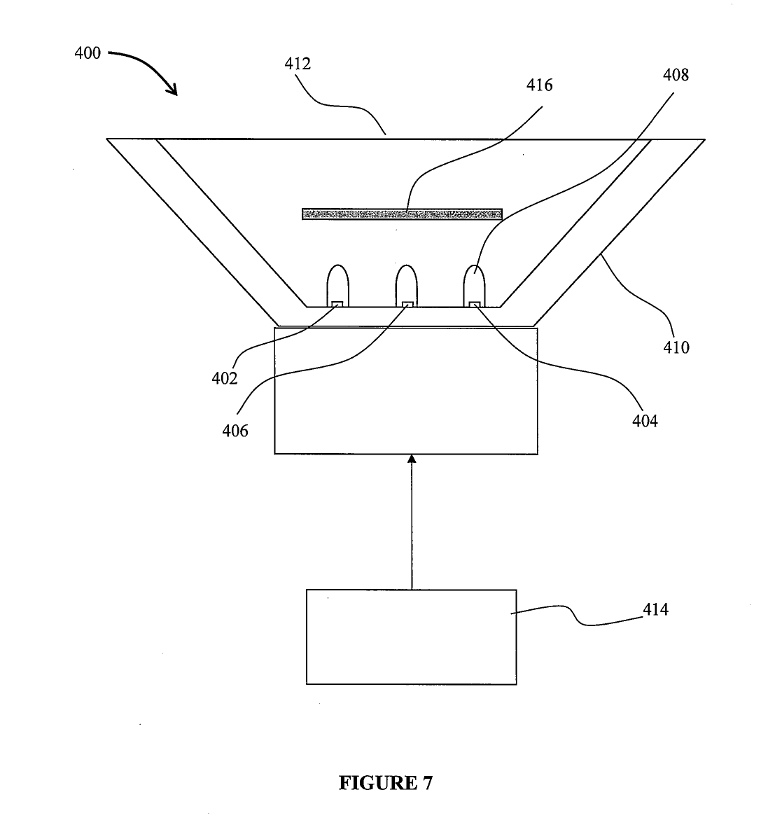

In yet another embodiment, the light-excitable medium may be positioned on an external transmissive plate within the light source housing (e.g. see FIGS. 7, 9 and 10), for example. As such, it could be possible to operate the light source in two modes, the first would include the plate and would thereby provide an output quality enhancement, whereas the second would not include the plate, and thus provide a lower output quality. Furthermore, this embodiment may provide the benefit of replacing the light-excitable medium without replacing the light-emitting elements. For instance, in the event that a light-excitable medium's degradation exceeds that of the light-emitting elements, one could contemplate replacing the light-excitable medium with a new one.

Furthermore, by applying the light-excitable medium to a component separate from the light-emitting elements, the light-excitable medium may be subjected to reduced heating, which could result in a prolonged life thereof. In general, the temperature range that the light-excitable medium is subjected to when disposed on or within a remote component is often much less than the range it would be subjected to if it where disposed directly on the light-emitting element die or chip. For example, the temperature range that a light-emitting element encapsulant must withstand is about −40 to about 260° C., whereas that for a remote component is typically about −40 to 60° C. Since certain light-excitable media are highly affected by temperature changes, this embodiment may become useful when using such temperature sensitive media. As an example, the efficiency of YAG phosphors decreases by 40% when the operating temperature is increased from about 100 to 250° C. As such, an embodiment comprising a light-excitable medium disposed on a remote component of the light source may avoid this problem.

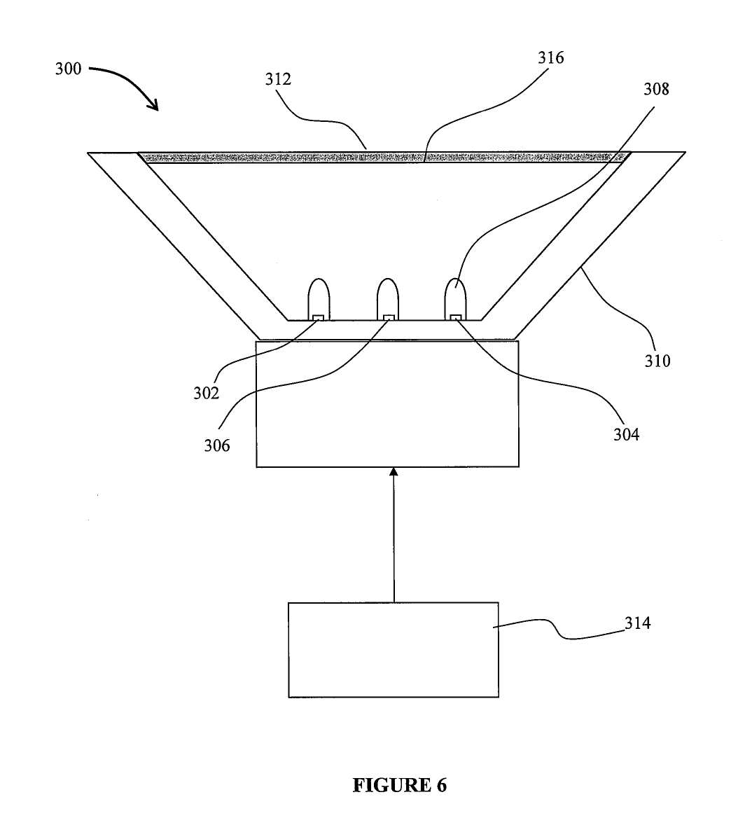

Other such light-excitable medium configurations within the light source may also be considered. For instance, the light-excitable medium may be applied to the output optics of the light source (e.g. see FIG. 6), to the housing, or to another part of the light source positioned to receive at least a portion of the light emitted by the one or more pump light-emitting elements. In an embodiment of the present invention, wherein the light-excitable medium is disposed so to be used in a transmissive mode, the light-excitable medium may be interspersed in a transparent medium, such as epoxy or the like, whereas when disposed to be used in a reflective mode, it may be applied to a mirror surface such as aluminized acrylic or the like, for example. These and other such variations should be apparent to the person of skill in the art and are thus not meant to depart from the general scope and nature of the present disclosure.

Optical Quality

As presented above, the light source provides an improved output optical quality as compared to that available using only the one or more light-emitting elements in each of the at least first, second and third colours. Generally, the optical quality of the light source may be defined as the spectral quality of the light source, that is, the ability of the light source to produce an output spectral power distribution having desirable characteristics and/or yielding desirable results when used to illuminate an object. Such characteristics/results, commonly encompassed within the meaning of the light source's output quality, may include, but are not limited to, one or more of an output chromaticity, colour temperature, CRI, colour quality, efficiency, and other such optical/operational qualities as would be readily understood by the person skilled in the art.

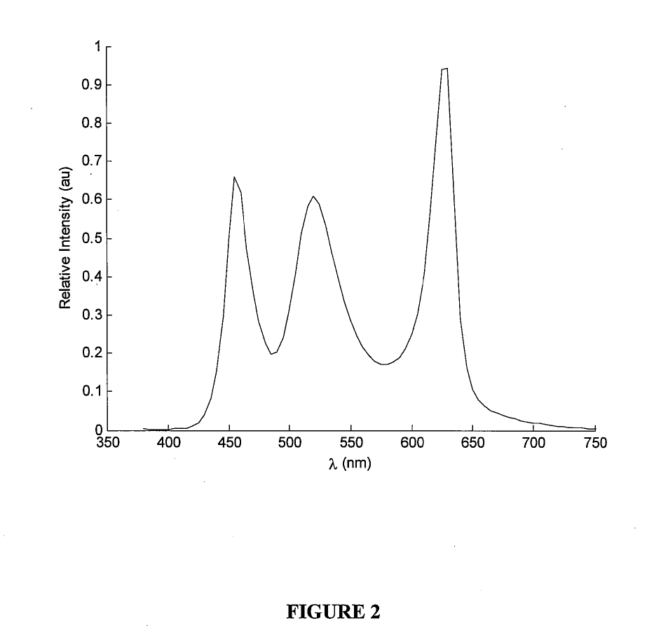

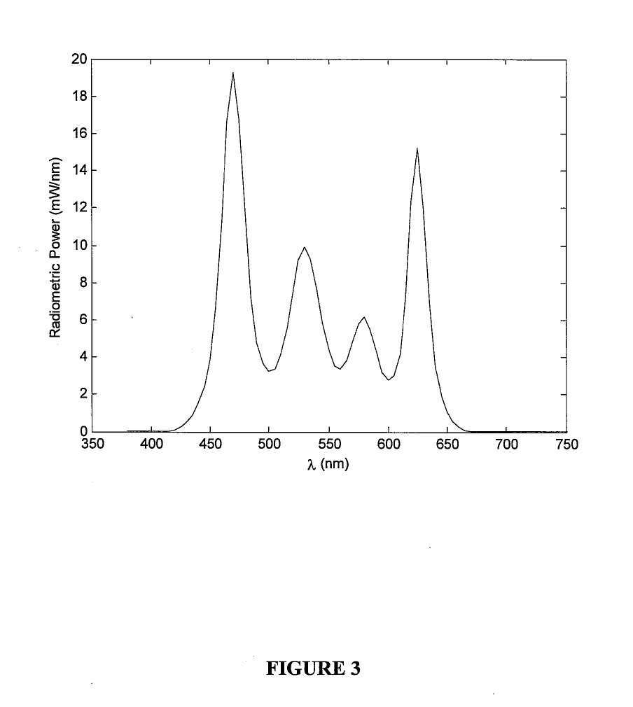

For example, in one embodiment, the output quality of the light source is defined by the CRI thereof, wherein the combination of the light emitted by the light-excitable medium with the light emitted by the light-emitting elements increases the CRI of the light source. In Examples 7 and 8 (FIGS. 2 and 3, respectively), such improvements are reported for a light source comprising a broadband and a narrowband light-excitable medium, respectively. These light sources each comprise one or more light-emitting elements in each of at least three colours, and a light-excitable medium configured to absorb a portion of the light emitted by the light-emitting elements and re-emit light at a peak wavelength located within a range of about 550 nm to about 600 nm.

The person of skill in the art will readily understand that other output qualities may be affected in a similar manner by combining such a light-excitable medium with light-emitting elements of at least a first, a second and a third colour, as described herein. For instance, by adjusting the relative intensities of the different colour light-emitting elements, and thereby also adjusting the relative intensity of the light emitted by the light-excitable medium, the output chromaticity, colour temperature, CRI, efficiency and/or colour quality of the light source may be adjusted with greater results than would otherwise be available without the light-excitable medium.

In one embodiment of the present invention, the light source further comprises a feedback system for monitoring the output of the light source and optionally adjusting the respective outputs of the various light-emitting elements, groups, arrays or clusters thereof, to substantially maintain a desired output quality. For instance, the light source may comprise one or more optical sensors for detecting a spectral output of the light source and communicating these measurements to a light source monitoring and control module (e.g. microcontroller, integrated hardware, software and/or firmware, etc.). This monitoring and control module can then adjust a drive current provided to the light-emitting elements and thereby adjust a combined output of the light source.

For example, the light source may comprise one or more light-emitting elements in each of at least a first, a second and a third colour, as described above, and a light-excitable medium configured and disposed to absorb a portion of the light emitted by one or more of the light-emitting elements and emit light within a spectral concavity defined by the combined output of the light-emitting elements. Using an optional sensing element configured to detect an output of the light source, a spectral output provided by the light-emitting elements, and indirectly by the light-excitable medium, may be adjusted.

In one embodiment of the present invention, using red, green and blue light-emitting elements and a light-excitable medium triggered only by a blue light-emitting element, the spectral output of the light source may be adjusted by independently adjusting the output intensity of the red, green and blue light-emitting elements, and indirectly adjusting the intensity of the light-excitable medium via adjustment of the blue intensity. In another embodiment using red, green and blue light-emitting elements and a light-excitable medium triggered by both the blue and green light-emitting elements, the spectral output of the light source may be adjusted by independently adjusting the output intensity of the red, green and blue light-emitting elements and adjusting the intensity of the light-excitable medium via adjustment of the green and blue intensities. Other such combinations should be apparent to the person skilled in the art.

In another embodiment, the light source may comprise three visible light-emitting element colours (e.g. red, green and blue), and one partially or fully invisible light-emitting element (e.g. UV, near-UV, IR, near-IR, etc.) such that an output intensity of the light-excitable medium is not linked to the intensity of the visible light-emitting elements. This embodiment could provide even greater versatility and/or adjustability as it can provide four independently adjustable outputs. For example, the relative intensity of each light-emitting element could be adjusted relative to a substantially constant background spectral power distribution provided by the light-excitable medium and maintained by the UV or near-UV light-emitting element. Alternatively, this background spectral power distribution could also be adjusted. Adjustment of each element's relative intensity, optionally as a function of a monitored light source output, may thus lead to greater control on the output optical quality of the light source.

In each of the above and other such embodiments, the output quality of the light source may be tuned to a desired output quality and substantially maintained by the adjustability of the light-emitting element outputs, and at least in part, due to these adjustments relative to the output of the light-excitable medium. This optional monitoring and control system, otherwise referred to as an output feedback mechanism or system, may help maintain a desired light source output quality during use. Since the output of a light-emitting element and/or of a light-excitable medium may change during use or with age (e.g. thermal effects, ageing effects, etc.), using such optional monitoring and control systems may allow to better maintain a desired output quality. For example, if the output spectral power distribution of one or more of the light-emitting elements, or again of the light-excitable medium, changes, the outputs thereof may be adjusted to provide a desired output quality. This may also be applicable, for example, when seeking to maintain a desired colour quality (e.g. CRI, CQS, etc.) for different colour temperatures. As a result, a same light source could be used for different applications requiring different output quality characteristics, and that, using a same set of light-emitting elements and light-excitable medium.

The invention will now be described with reference to specific examples. It will be understood that the following examples are intended to describe embodiments of the invention and are not intended to limit the invention in any way.

### EXAMPLES

### Example 1

Referring now to FIG. 4, a light source, generally referred to using the numeral 100, and in accordance with one embodiment of the present invention, will now be described. The light source 100 generally comprises one or more light emitting elements in each of at least a first, a second and a third colour, e.g. red, green and blue (RGB), as in elements 102, 104 and 106, respectively. The light-emitting elements 102, 104 and 106 are mounted within respective packages, as in package 108, which are themselves mounted within a light source housing 110, or the like.

The packages 108 generally provide a primary output optics for directing at least a portion of the light emitted by the light-emitting elements 102, 104 and 106. Such output optics may include, but are not limited to, one or more lenses, diffusers, filters and/or other such optical elements, as will be readily understood by the person skilled in the art.

The housing 110 generally comprises a body defining an inner cavity within which the light-emitting elements 102, 104 and 106 may be mounted and operated, and an output 112. As will be apparent to the person skilled in the art, the housing 110 may comprise a number of optical and/or non-optical components to provide a variety of optical effects. These components may include, but are not limited to, one or more reflective surfaces, lenses, diffusers, filters, and the like, used in different combinations to provide a desired effect.

It is to be understood that although the light source 100 is illustrated as comprising three discrete light-emitting elements of different colours, a combination, cluster, configuration, agglomeration and/or array of such elements may also be considered without departing from the general scope and nature of the present disclosure. Also, the person of skill in the art will understand that one or more light-emitting elements, whether they be of a same or different colour, of a same or different type, and/or of a same or different size, may be mounted and operated within respective packages 108, as illustrated herein, or within one or more shared packages.

Furthermore, various optical and/or operational configurations may be considered. Namely, the light source 100 may comprise three or more independent light-emitting elements, as illustrated here, or one or more arrays of such elements for each selected colour (e.g., an array of red light-emitting elements, an array of green light-emitting elements and an array of blue light-emitting elements, etc.), and that, in different combinations and/or spatial configurations.

The light emitting elements 102, 104 and 106 are generally mounted within their respective housings 108 on a substrate or the like. A shared and/or respective driving means, for example a driver, driving module, driving circuitry or the like, is operatively coupled between a power source 114 and the light-emitting elements 102, 104 and 106, for example via their respective substrates, to drive the light-emitting elements 102, 104 and 106. Optional control means, such as a micro-controller of the like, may also be included and operatively coupled to the driving means in order to control, and possibly optimise, an output of the light-emitting elements 102, 104 and 106. Various driving and optional control means may be considered herein without departing from the general scope and nature of the present disclosure, as will be apparent to the person skilled in the art, and thus, need not be further described herein.

In general, a combined spectral power distribution of the light-emitting elements 102, 104 and 106 may have the general profile exhibited in FIG. 1, namely a combination of three peak outputs corresponding to each light-emitting element colour, and a spectral concavity A between the red and green peaks.

In order to compensate for the lack of spectral content within the spectral concavity, and thereby improve an output quality of the light source 100, a light-excitable medium 116, such as a phosphor or the like, is embedded within the package 108 of the blue light-emitting element 106. As such, blue light emitted by the light-emitting element 106 may be absorbed by the light-excitable medium 116 and re-emitted within a range conducive to improving an output quality of the light source. For example, an emission of the light-excitable medium 116 may comprise a narrowband or broadband spectral component having a peak located within concavity A. For example, the peak may be located within a range of between about 550 nm and about 600 nm, a range of between about 560 nm and about 590 nm, a range of between about 570 and about 585 nm, or within other like ranges.

It will be appreciated that the light-excitable medium may equally be selected to be excited (e.g. pumped) by the green light-emitting element, the red light-emitting element and/or a combination of the blue and green light-emitting elements, for example.

### Example 2

Referring now to FIG. 5, a light source, generally referred to using the numeral 200, and in accordance with one embodiment of the present invention, will now be described. The light source 200 is designed, and may be operated, much like the light source 100 of Example 1. It generally comprises one or more light emitting elements in each of at least a first, a second and a third colour, e.g. red, green and blue (RGB), as in elements 202, 204 and 206, respectively, which are mounted within respective and/or shared packages 208, themselves mounted within a light source housing 210, or the like.

In this example, however, a light-excitable medium 216, such as a phosphor or the like, is provided on an inner and/or outer surface of the blue light-emitting element's package 208. For instance, if the package 208 of the blue light-emitting element 206 defines a primary output lens, the light-excitable medium 216 may be disposed on an outer surface of this lens. As such, blue light emitted by the light-emitting element 206 may be absorbed by the light-excitable medium 216 and re-emitted within a range conducive to improving an output quality of the light source. For example, an emission of the light-excitable medium 216 may again comprise a narrowband or broadband spectral component having a peak located within concavity A of FIG. 1, namely within a range as defined in Example 1 above.

It will again be appreciated that the light-excitable medium may equally be selected to be excited (e.g. pumped) by the green light-emitting element, the red light-emitting element and/or a combination of the blue and green light-emitting elements, for example.

### Example 3

Referring now to FIG. 6, a light source, generally referred to using the numeral 300, and in accordance with one embodiment of the present invention, will now be described. The light source 300 is designed, and may be operated, much like the light source 100 of Example 1. It generally comprises one or more light emitting elements in each of at least a first, a second and a third colour, e.g. red, green and blue (RGB), as in elements 302, 304 and 306, respectively, which are mounted within respective and/or shared packages 308, themselves mounted within a light source housing 310, or the like.

In this example, however, a light-excitable medium 316, such as a phosphor or the like, is provided on an inner and/or outer surface, or again is embedded within an output 312 of the housing 310. For instance, if the light source output 312 defines a primary or secondary output lens, the light-excitable medium 316 may be disposed on an inner and/or outer surface of this lens, and/or may be embedded within this lens. As such, blue light emitted by the light-emitting element 306 may be absorbed by the light-excitable medium 316 as it reaches the output 312 and be re-emitted within a range conducive to improving an output quality of the light source. For example, an emission of the light-excitable medium 316 may again comprise a narrowband or broadband spectral component having a peak located within concavity A of FIG. 1, namely within a range as defined in Example 1 above.

It will again be appreciated that the light-excitable medium may equally be selected to be excited (e.g. pumped) by the green light-emitting element, the red light-emitting element and/or a combination of the blue and green light-emitting elements, for example.

### Example 4

Referring now to FIG. 7, a light source, generally referred to using the numeral 400, and in accordance with one embodiment of the present invention, will now be described. The light source 400 is designed, and may be operated, much like the light source 100 of Example 1. It generally comprises one or more light emitting elements in each of at least a first, a second and a third colour, e.g. red, green and blue (RGB), as in elements 402, 404 and 406, respectively, which are mounted within respective and/or shared packages 408, themselves mounted within a light source housing 410, or the like.

In this example, however, a light-excitable medium 416, such as phosphor or the like, is provided as a separate element disposed within the housing 410 such that blue light emitted by the light-emitting element 406 may be absorbed by the light-excitable medium 416 and re-emitted within a range conducive to improving an output quality of the light source. For example, an emission of the light-excitable medium 416 may again comprise a narrowband or broadband spectral component having a peak located within concavity A of FIG. 1, namely within a range as defined in Example 1 above.

It will again be appreciated that the light-excitable medium may equally be selected to be excited (e.g. pumped) by the green light-emitting element, the red light-emitting element and/or a combination of the blue and green light-emitting elements, for example.

### Example 5

Referring now to FIG. 8, a light source, generally referred to using the numeral 500, and in accordance with one embodiment of the present invention, will now be described. The light source 500 is designed, and may be operated, much like the light source 100 of Example 1. It generally comprises one or more light emitting elements in each of at least a first, a second and a third colour, e.g. red, green and blue (RGB), as in elements 502, 504 and 506, respectively, which are mounted within respective and/or shared packages 508, themselves mounted within a light source housing 510, or the like.

In this example, however, the light source 500 further comprises one or more additional light-emitting elements in a fourth colour, for example one or more ultra-violet (UV) or infra-red (IR) light-emitting elements 509, a light-excitable medium 516, such as a phosphor or the like, being embedded within a housing of the additional light-emitting element(s) 509. As such, UV or IR light emitted by the light-emitting element(s) 509 may be absorbed by the light-excitable medium 516 and re-emitted within a range conducive to improving an output quality of the light source. For example, an emission of the light-excitable medium 516 may again comprise a narrowband or broadband spectral component having a peak located within concavity A of FIG. 1, namely within a range as defined in Example 1 above.

It will be appreciated that the light-excitable medium may equally be selected to be excited (e.g. pumped) by a combination of the green light-emitting element and/or blue light-emitting element, and an additional UV light-emitting element(s), or a combination of the red light-emitting element and an additional IR light-emitting element(s), and disposed, for example as depicted in the examples of FIGS. 6 and 7, to allow for an excitation thereof by such combinations.

### Example 6

FIG. 2 provides a graphical representation of the spectral output of an RGB light source comprising a light-excitable medium in accordance with one embodiment of the present invention. The light-excitable medium is generally disposed such that a portion of the light emitted by the blue and/or green light-emitting elements (i.e. peak outputs at about 470 nm and about 520 nm respectively), or by a UV and/or near UV light-emitting element, is absorbed and re-emitted as a broadband output having a peak located between about 550 nm and about 600 nm, between about 560 nm and about 590 nm, between about 570 nm and about 585 nm, or at about 575+/−5 nm or about 580+/−5 nm. When compared to the spectral output of FIG. 1, which represents the output of an RGB light source exhibiting a spectral concavity A having a minimum B, the peak of the broadband spectral power distribution emitted by the light-excitable medium falls within this concavity thereby increasing the spectral content of the light source in this region. Furthermore, due to the broadband nature of the light-excitable medium, the spectral output is increased in other regions otherwise deficient in and/or lacking spectral content, namely within the far red region above about 650 nm. Consequently, an output quality of the light source is improved by this redistribution of spectral outputs. In this example, the CRI of this light source is increased from 47 to 63 when the broadband light-excitable medium is used.

### Example 7

FIG. 3 provides a graphical representation of the spectral output of an RGB light source comprising a light-excitable medium in accordance with one embodiment of the present invention. The light-excitable medium is generally disposed such that a portion of the light emitted by the blue and/or green light-emitting elements (i.e. peak outputs at about 470 nm and about 520 nm respectively), or by a UV and/or near UV light-emitting element, is absorbed and re-emitted as a narrowband output having a peak located between about 550 nm and about 600 nm, between about 560 nm and about 590 nm, between about 570 nm and about 585 nm, or at about 575+/−5 nm or about 580+/−5 nm. When compared to the spectral output of FIG. 1, which represents the output of a traditional RGB light source exhibiting a spectral concavity A having a minimum B, the peak of the narrowband spectral power distribution emitted by the light-excitable medium falls within this concavity thereby improving an output quality of the light source. In this example, the CRI of this light source is increased from 47 to 79 when the narrowband light-excitable medium is used.

### Example 8

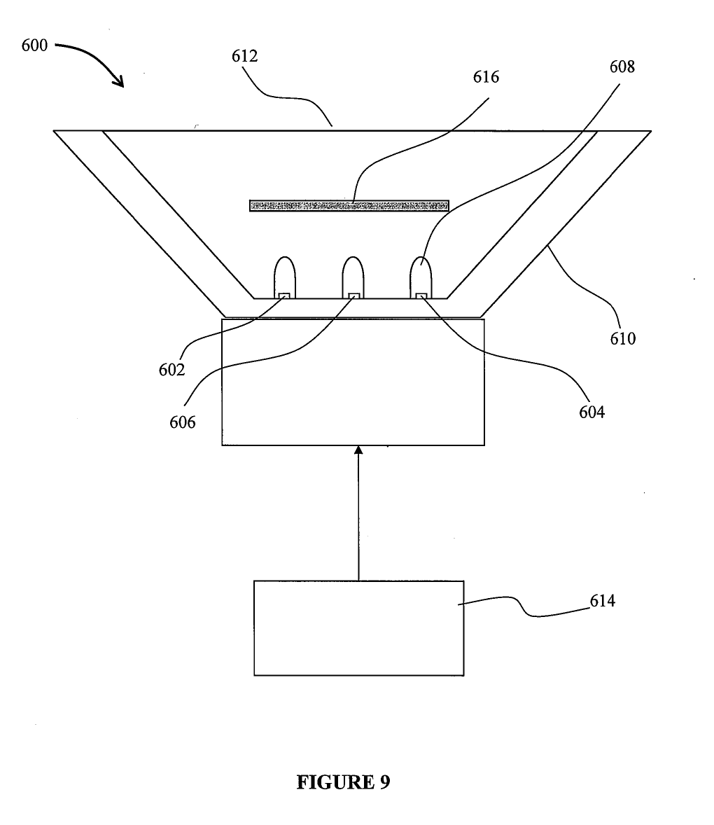

Referring now to FIG. 9, a light source, generally referred to using the numeral 600, and in accordance with one embodiment of the present invention, will now be described. The light source 600 is designed, and may be operated, much like the light source 100 of Example 1. It generally comprises one or more light emitting elements in each of at least a first, a second and a third colour, e.g. red, green and blue (RGB), as in elements 602, 604 and 606, respectively, which are mounted within respective and/or shared packages 608, themselves mounted within a light source housing 610, or the like.

In this example, a light-excitable medium 616, which may comprise a combination of one or more phosphors or the like, or again be defined by a material exhibiting two or more peak emission wavelengths or spectra, for example, is provided as a separate element disposed within the housing 610 such that blue light emitted by the light-emitting element 606 may be absorbed by the light-excitable medium 616 and re-emitted within a combination of ranges conducive to improving an output quality of the light source. For example, an emission of the light-excitable medium 616 may again comprise a narrowband or broadband spectral component having a peak located within concavity A of FIG. 1, namely within a range as defined in Example 1 above, as well as a narrowband or broadband spectral component having a peak located at lower wavelengths, namely exhibiting a colour ranging from green to yellow for example. This embodiment may provide an improved output quality when, for example, a green or yellow-green light-emitting element exhibits a lower output efficiency and/or peak intensity relative to a blue light-emitting element for example. As such, by down-converting a portion of the blue light emitted by the blue light-emitting element toward green or yellow, an output of the light source in the green or yellow region of the visible spectrum will be increased relative to the output in the blue region of the spectrum, potentially providing a better adjusted light source spectral power distribution for the application at hand.

### Example 9

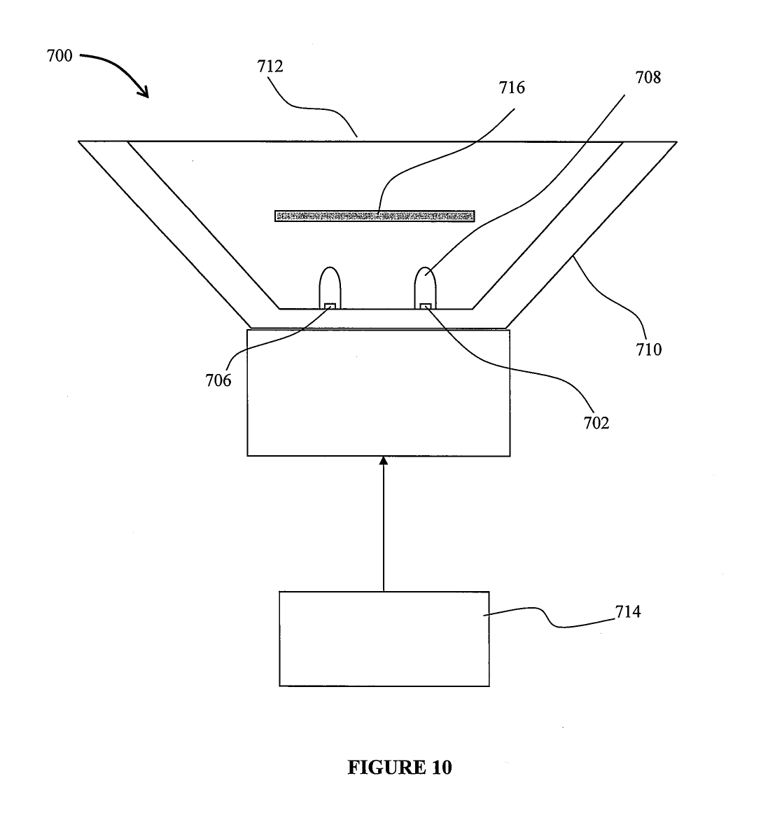

Referring now to FIG. 10, a light source, generally referred to using the numeral 700, and in accordance with one embodiment of the present invention, will now be described. The light source generally comprises one or more light emitting elements in each of at least a first and a second colour, e.g. red and blue, as in elements 702 and 706, respectively, which are mounted within respective and/or shared packages 708, themselves mounted within a light source housing 710, or the like.

In this example, a light-excitable medium 716, which may comprise a combination of one or more phosphors or the like, or again be defined by a material exhibiting one or more peak emission wavelengths or spectra, for example, is provided as a separate element disposed within the housing 710 such that blue light emitted by the light-emitting element 706 may be absorbed by the light-excitable medium 716 and re-emitted within a one or more spectral ranges conducive to improving an output quality of the light source. For example, an emission of the light-excitable medium 716 may again comprise a narrowband or broadband spectral component having a peak located within concavity A of FIG. 1, or again within a spectral deficiency exhibited in this range, namely within a range as defined in Example 1 above, thereby providing a combined spectral power distribution exhibiting peaks, for example, in the red, orange/amber and blue regions of the visible spectrum, for example.

The emission of the light-excitable medium 716 may further comprise a narrowband or broadband spectral component having a peak located at lower wavelengths, namely exhibiting a colour ranging from green to yellow for example, the combined spectral power distribution of the light source thereby exhibiting peaks in the red, green/yellow, orange/amber and blue regions of the visible spectrum, for example.

It will be appreciated that an additional light-emitting element, such as a UV light-emitting element, may be used to pump the light-excitable medium or media, or again supplement a pumping of the light-excitable medium provided by the blue light-emitting element. It will also be appreciated that an up-conversion light-excitable medium may be used to provide a similar effect. It will again be appreciated that the light-excitable medium may equally be selected to be excited (e.g. pumped) by the red light-emitting element, for example.

The person of skill in the art will understand that the foregoing embodiments of the invention are examples and can be varied in many ways. Such present or future variations are not to be regarded as a departure from the spirit and scope of the invention, and all such modifications as would be apparent to one skilled in the art are intended to be included within the scope of the following claims.

We claim:

1. A light source, comprising:
one or more light-emitting elements in each of at least a first, a second and a third colour, a combined spectral power distribution thereof defining a spectral concavity having a minimum located between about 550 nm and about 600 nm; and
a light-excitable medium configured and disposed to absorb a portion of the light emitted by one or more of said light-emitting elements and emit light defined by a complementary spectral power distribution having a peak located within said concavity;
wherein an optical quality of the light source output is improved by a combination of said complementary spectral power distribution with said combined spectral power distribution.

2. The light source as claimed in claim 1, wherein said complementary spectral power distribution is a substantially narrowband spectral power distribution.

3. The light source as claimed in claim 2, wherein a half-width of said narrowband spectral power distribution is lesser than that of one or more of said light-emitting elements.

4. The light source as claimed in claim 2, wherein a half-width of said narrowband spectral power distribution is lesser than that of said spectral concavity.

5. The light source as claimed in claim 1, wherein said complementary spectral power distribution is a substantially broadband spectral power distribution.

6. The light source as claimed in claim 5, wherein a half-width of said broadband spectral power distribution is greater than that of one or more of said light-emitting elements.

7. The light source as claimed in claim 5, wherein a half-width of said broadband spectral power distribution is greater than that of said spectral concavity.

8. The light source as claimed in claim 1, wherein said minimum is located between about 560 nm and about 590 nm.

9. The light source as claimed in claim 1, wherein said minimum is located between about 570 nm and about 585 nm.

10. The light source as claimed in claim 1, wherein said minimum is located between about 575 nm and about 580 nm.

11. The light source as claimed in claim 1, the light source comprising one or more light-emitting elements in a fourth substantially invisible colour, said light-excitable medium configured and disposed to absorb a portion of the light emitted by said one or more light-emitting elements in said fourth colour.

12. The light source as claimed in claim 11, wherein said fourth colour is selected from the group consisting of infrared, near-infrared, ultraviolet and near ultraviolet.

13. The light source as claimed in claim 1, said first, second and third colour consisting of red, green and blue respectively.

14. The light source as claimed in claim 13, the light source comprising a further light-excitable medium configured and disposed to emit green light to further improve said optical quality.

15. The light source as claimed in claim 1, said light-excitable medium being disposed on a package component of a selected one or more of said light-emitting elements, and configured to absorb a portion of the light emitted by said selected one or more of said light-emitting elements.

16. The light source as claimed in claim 1, said light-excitable medium being disposed on a light source component distinct from said light-emitting elements.

17. The light source as claimed in claim 1, said optical quality comprising one or more of a colour quality, a colour rendering index, a chromaticity and efficiency and a colour temperature of the light source.

18. The light source as claimed in claim 1, further comprising a feedback system operatively coupled to a driving mechanism of the light source for sensing said optical quality and adjusting same as required by adjusting an output of said light-emitting elements via said driving mechanism.

19. The light source as claimed in claim 1, wherein said light-excitable medium comprises a phosphorescent material.

20. A light source, comprising:
one or more light-emitting elements in each of at least a first and a second colour, a combined spectral power distribution thereof defining a spectral deficiency between about 550 nm and about 600 nm; and
one or more light-excitable media configured and disposed to absorb a portion of the light emitted by one or more of said light-emitting elements and emit light defined by a complementary spectral power distribution having a peak located between about 550 nm and about 600 nm;
wherein an optical quality of the light source output is improved by a combination of said complementary spectral power distribution with said combined spectral power distribution.

21. The light source as claimed in claim 20, wherein said first colour is defined by a peak wavelength ranging between about 600 nm and 690 nm, and wherein said second colour is defined by a peak wavelength ranging between about 430 nm and 550 nm.

22. The light source as claimed in claim 21, wherein said first colour is red and said second colour is blue.

23. The light source as claimed in claim 20, said complementary spectral power distribution having a further peak located below about 550 nm thereby further improving said optical quality.

24. The light source as claimed in claim 23, wherein said first colour is red, said second colour is blue, and said complementary spectral power distribution comprises a first peak exhibiting a colour ranging from orange to amber and a second peak exhibiting a colour ranging from green to yellow.

25. The light source as claimed in claim 24, the light source further comprising one or more light-emitting elements in a third colour ranging from about green to yellow.
